(19) United States
(12) Patent Application Publication
(10) Pub. No.: US 2011/0047381 A1
(43) Pub. Date: Feb. 24, 2011

(54) SAFEMASHUPS CLOUD TRUST BROKER

(75) Inventors: Ravi GANESAN, Half Moon Bay, CA (US); Todd Wolff, Boerne, TX (US)

Correspondence Address: ALFRED A. STADNICKI, 1300 NORTH SEVENTEENTH STREET, SUITE 1800, ARLINGTON, VA, 22209, US

(73) Assignee: BOARD OF REGENTS, THE UNIVERSITY OF TEXAS SYSTEM, Austin, TX (US)

(21) Appl. No.: 12/859,986

(22) Filed: Aug. 20, 2010

Related U.S. Application Data
(60) Provisional application No. 61/235,766, filed on Aug. 21, 2009.

(51) Int. Cl. H04L 29/06; G06F 17/00; H04L 9/32

(52) U.S. Cl. 713/169; 726/1

(57) ABSTRACT

The present invention provides a new method for policy enforcement in a virtualized or cloud environment. We break down the environment into layers, which are further sub-divided into security units. Each security unit has a security profile based on its own security properties and those of the layers below. The security profile also reflects the floor, ceiling and wall security properties. Each security unit has an agent which is used to establish communications with other security units. Such communication is mediated by a cloud trust broker which determines if the communication is permitted based on access control list or else retrieves the security profiles and applies pre-defined rules. If the communications are allowed the cloud trust broker runs a mutual authentication and key distribution protocol that results in the two security units obtaining a session key which they can then use for further communications which can proceed directly.

### RELATED APPLICATIONS

This application claims priority based on Provisional U.S. Application Ser. No. 61/235,766, filed Aug. 21, 2009, and entitled “SafeMashups Cloud Trust Broker”, the contents of which are incorporated herein in their entirety by reference.

### TECHNICAL FIELD

This invention relates to security and privacy. More particularly it relates to security of cloud based services.

### BACKGROUND OF THE INVENTION

Virtualization and cloud computing introduce entirely new security challenges. For example, the economic benefits of virtualization suggest that all the computing horsepower of an enterprise, be it servers in multiple hardened data centers or employee desktops, be treated as one large computing resource, across which processing and data freely move to take advantage of efficiencies. However, an employee desktop might have a very different security profile from a server room in an office versus a server in a hardened data center. Consequently from a security perspective it is critical to maintain control on where applications and data reside. Similarly when outsourcing a business process to a cloud provider, it is now increasingly likely that the vendor providing the business process might well in turn be outsourcing underlying compute layers from another vendor who in turn might well be outsourcing the underlying facilities to yet another vendor. Consequently visibility into the security controls is now harder to obtain.

We describe an innovation, the SafeMashups Cloud Trust Broker, which allows enterprises to regain visibility and control in such complex environments.

### OBJECTIVES OF THE INVENTION

This invention has the following objectives:
The introduction of a layered security model where each layer has security properties defined in a security profile.
Dividing any given layer into security units which inherit the overall security properties of the layer, but which then can have different properties from each other, to further specialize the security profile.
Defining the floor, ceiling and wall security properties of the security units to further specialize the security profile.
Introduce the concept of a security agent into each security unit.
Introduce the concept of a cloud trust broker that mediates communications between the security units (via the security agents), permitting such communications only when permitted by rules derived from an access control list or a policy.

Additional objects, advantages, novel features of the present invention will become apparent to those skilled in the art from this disclosure, including the following detailed description, as well as by practice of the invention. While the invention is described below with reference to preferred embodiment(s), it should be understood that the invention is not limited thereto. Those of ordinary skill in the art having access to the teachings herein will recognize additional implementations, modifications, and embodiments, as well as other fields of use, which are within the scope of the invention as disclosed and claimed herein and with respect to which the invention could be of significant utility.

### SUMMARY DISCLOSURE OF THE INVENTION

Our first objective is the introduction of a layered security model where each layer has security properties defined in a security profile.

Our second objective is to divide any given layer into security units which inherit the overall security properties of the layer, but which then can have different properties from each other, to further specialize the security profile.

Our third objective is to define the floor, ceiling and wall security properties of the security units to further specialize the security profile.

Our fourth objective is to introduce the concept of a security agent into each security unit.

Our fifth objective is to introduce the concept of a cloud trust broker that mediates communications between the security units (via the security agents), permitting such communications only when permitted by rules derived from an access control list or a policy.

### BRIEF DESCRIPTION OF DRAWINGS

FIG. 1 describes the preferred seven vertical layers in the cloud model. Layer 1 is are the physical facilities, Layer 2 the hardware, Layer 3 the virtualization layer, Layer 4 the guest operating systems, Layer 5 the applications, Layer 6 the user desktop and Layer 7 the user browser.

FIG. 2 shows how each layer in turn can be split into different security units.

FIG. 3 shows the introduction of an agent and a security profile resident in each security unit.

FIG. 4 shows how the Cloud Trust Broker mediates communications between different security units.

### PREFERRED EMBODIMENT(S) OF THE INVENTION

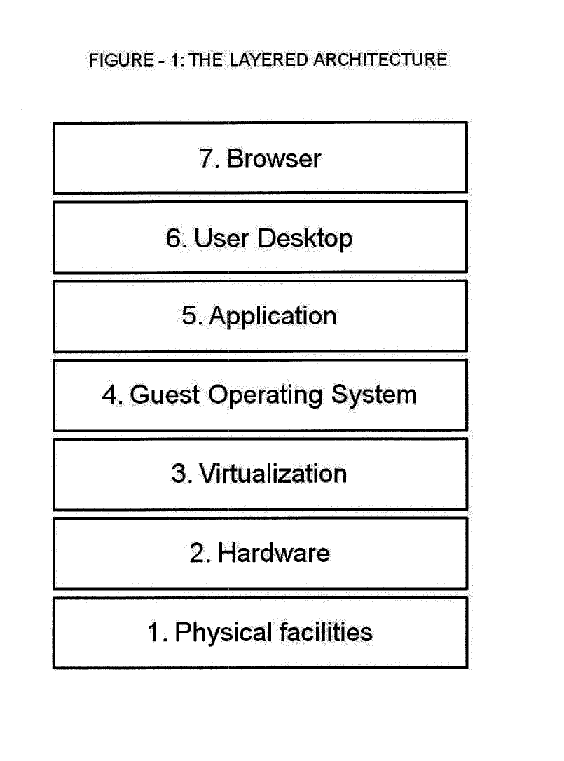

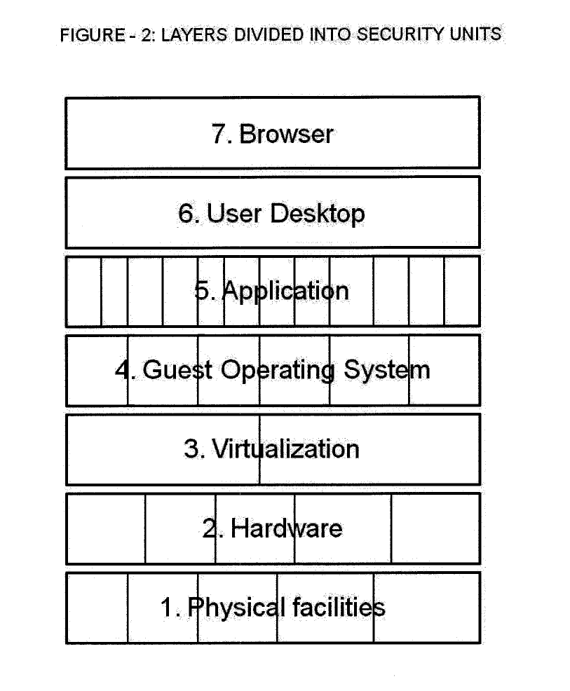

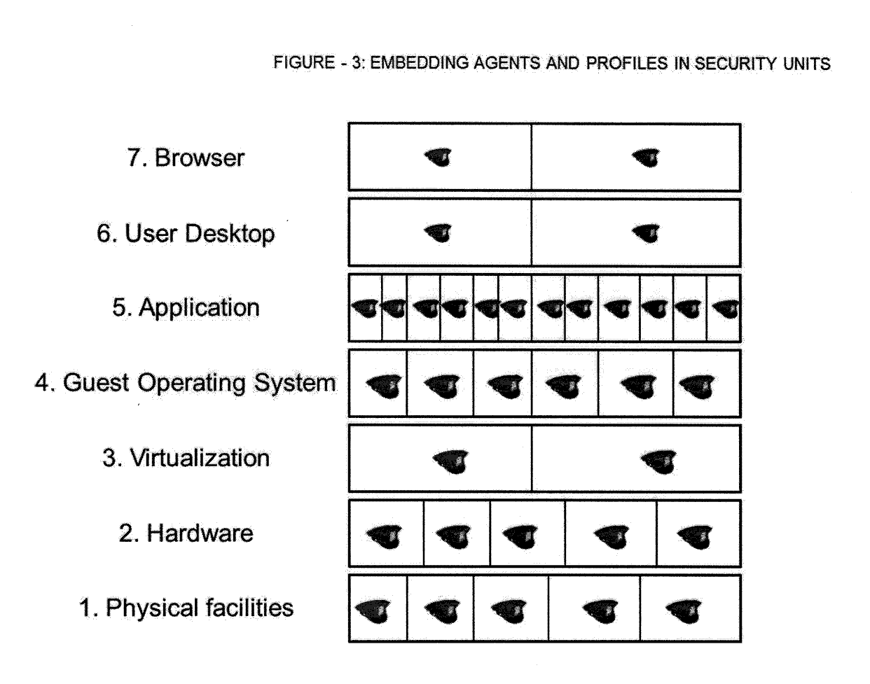

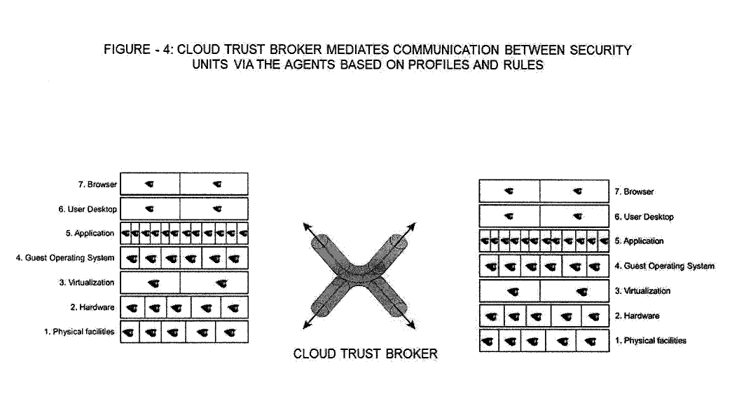

The set up for our preferred embodiment is as follows:
We take any cloud environment and organize it into a seven layer stack. The first five layers reside at the back-end. Layer 1 as shown in FIG. 1 are the physical facilities (for example a data center), Layer 2 the actual hardware (processors and storage), Layer 3 the virtualization layer (the hypervisor), Layer 4 the guest operating systems that run on the hypervisor and Layer 5 the actual applications running on top of the operating system. The last two layers are optionally included and comprise of Layer 6 the user desktop operating system and Layer 7 the browser. Each of these layers has a security profile defined in a language such as XML with the security properties of the layer, and those of the layers below it. These security properties could include signatures attesting to their validity. This is as shown in FIG. 1.
We then split each layer into security units as shown in FIG. 2. For instance in a shared data center different enterprises typically have “cages” housing their own equipment. Or one could run operating systems with very different security properties on top of a single virtualization layer. Each security unit consequently has its own security profile, and two security units at the same layer could have very different security properties.
We ensure that each security unit's security profile include statements on the “floor, ceiling and wall” security properties. In general it is assumed that someone with control of a lower layer can break into the upper layer, but it should definitely be the goal to ensure that one cannot tunnel down a layer, or through a wall. These considerations can be reflected in the security properties.
We then introduce an agent into each security unit which will communicate to the cloud trust broker. This agent might be a separate process or could be built natively into the security unit itself. This is shown in FIG. 3.
Finally we introduce the cloud trust broker which sits in a separate secure location and will mediate communications between security units. This is shown in FIG. 4.

When a first security unit wishes to communicate with a second security unit:
The agent on the first security unit initiates the request to the cloud trust broker.
The broker determines if communications between the two security units are permitted either by consulting a pre-defined access control list, or by retrieving each security unit's security profile and using pre-defined rules to determine if the security units are allows to communicate.
If communications are permissible, the broker runs a mutual authentication and key distribution protocol such as MashSSL between the two security units.
At the end of this process the two security units share a session key which they can use for further communications (which do not have to go through the broker).

This process ensures that an enterprise can enforce policies on which security units can share processing and data.

What is claimed is:

1. A method for enforcing security policies in a virtualized or cloud environment wherein:
a) the infrastructure is divided into layers encompassing physical facilities, hardware, virtualization, guest operating system, applications, user desktop and browser;
b) each layer is divided into security units;
c) each security unit contains security profiles with attestations about the security of the said unit, including attestations about the floor, ceiling and wall security properties;
d) each security unit has an agent that can be used to establish communications with other security units for the transfer of data or processing; and
e) a cloud trust broker is present to mediate such communications.

2. A method according to claim 1 wherein
a. when a first security unit wishes to communicate to a second security unit, it initiates a connection to the cloud trust broker;
b. which examines an access control list and determines if such communications are permissible, and if permissible;
c. runs a mutual authentication and key distribution protocol between the two security units;
d. resulting in the two security units obtaining a shared session key for further communications.

3. A method according to claim 2 wherein instead of consulting an access control list, the cloud trust broker retrieves the security profiles of both security units and makes a determination of whether communication is permissible based on a set of rules.
